(19) United States
(12) Patent Application Publication
(10) Pub. No.: US 2010/0214503 A1
(43) Pub. Date: Aug. 26, 2010

(54) DISPLAY PANEL AND REPAIR METHOD THEREOF

(75) Inventors: Yi-jin Lee, Taipei City (TW); Chi-chao Liu, Yunlin County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Chunghwa Picture Tubes, Ltd., Taoyuan (TW)

(21) Appl. No.: 12/434,206

(22) Filed: May 1, 2009

(30) Foreign Application Priority Data
Feb. 26, 2009 (TW) 098106255

(51) Int. Cl. G02F 1/1333; G02F 1/13

(52) U.S. Cl. 349/54; 349/192

(57) ABSTRACT

A display panel and a repair method thereof are disclosed. The display panel comprises a plurality of signal lines, having at least one first repair line and at least one second repair line. The first repair line and the second repair line are respectively disposed at both sides of the signal lines, and the signal lines are partially overlapped. The method comprises: electrically connecting the broken signal line and the first repair line; electrically connecting the broken signal line and the second repair line; and utilizing a flexible conductive component to electrically connect the first repair line and the second repair line.

### FIELD OF THE INVENTION

The present invention relates to a display panel and a repair method thereof and more particularly, to a display panel and a repair method for enhancing repair signal quality thereof.

### BACKGROUND OF THE INVENTION

Currently, a display panel, such as a liquid crystal display (LCD) panel, comprises a bottom glass substrate having a plurality of pixels and a plurality of signal lines, such as scanning lines and data lines. Each of the pixels receives the control signals, such as scanning signals and pixel voltage, from the corresponding signal line. The signal lines and the pixels form a display region on the bottom glass substrate.

Normally, the bottom glass substrate can have a plurality of repair lines (or rescue lines) thereon. The repair lines are partially formed on the bottom glass substrate and partially overlap the signal lines, i.e. the repair lines and the signal lines are partially crisscrossed, but not connected to each other. When one of the signal lines is broken, the broken signal line can be repaired by using laser to weld the overlapped portion between the signal lines and the repair lines for electrical connection. Therefore, the repair lines can replace the broken signal line to transmit the control signal to the corresponding pixel.

However, a portion of the repair lines is formed on the bottom glass substrate for transmitting signals, and the impedance of the repair lines formed thereon is very large, and thus it is susceptible to be resulted in the resistive-capacitive delay effect leading to the delay of the transmitting signals. Accordingly, when the repair lines can not repair the display panel successfully, the display panel has to be scrapped, and thereby raising the manufacturing cost.

### SUMMARY OF THE INVENTION

Therefore, an aspect of the present invention is to provide a display panel and a repair method thereof to reduce the signal transmission impedance after repairing the panel, thereby enhancing the signal transmission quality and the repair yield of the signal lines.

According to one embodiment of the present invention, the display panel comprises a substrate, a plurality of signal lines, at least one first repair line, at least one second repair line and a flexible conductive component. The signal lines are formed on the substrate, wherein at least one of the signal lines is broken. The first repair line is formed on one side of the signal lines and electrically connected to the broken signal line. The second repair line is formed on the opposite side of the signal lines and electrically connected to the broken signal line. The flexible conductive component is electrically connected between the first repair line and the second repair line.

According to another embodiment of the present invention, the repair method is applicable for a display panel which comprises a plurality of signal lines, at least one first repair line and at least one second repair line, and at least one of the signal lines is broken, and the first repair line and the second repair line are respectively formed on two opposite sides of the signal lines and partially overlap the signal lines, and the method comprises: electrically connecting the broken signal line and the first repair line; electrically connecting the broken signal line and the second repair line; and utilizing a flexible conductive component to electrically connect the first repair line and the second repair line.

Therefore, with the use of the display panel and the repair method thereof disclosed in the embodiments of the present invention, the signal lines thereon can be repaired by utilizing a flexible conductive component having lower impedance, thereby enhancing the signal transmission quality and the repair yield of the signal line

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a top view showing a display panel according to one embodiment of the present invention;

FIG. 2 is a top view showing a display panel according to another embodiment of the present invention;

FIG. 3 A and FIG. 3 B are schematic diagrams showing a display panel including repair lines on the substrate according to one embodiment of the present invention;

FIG. 4 is a flow diagram showing a repair method of the display panel according to one embodiment of the present invention;

FIG. 5 is a partial cross-section view showing the display panel according to one embodiment of the present invention; and

FIG. 6 is a top view showing a display panel according to yet another embodiment of the present invention.

### DETAILED DESCRIPTION OF THE PREFERRED EMBODIMENT

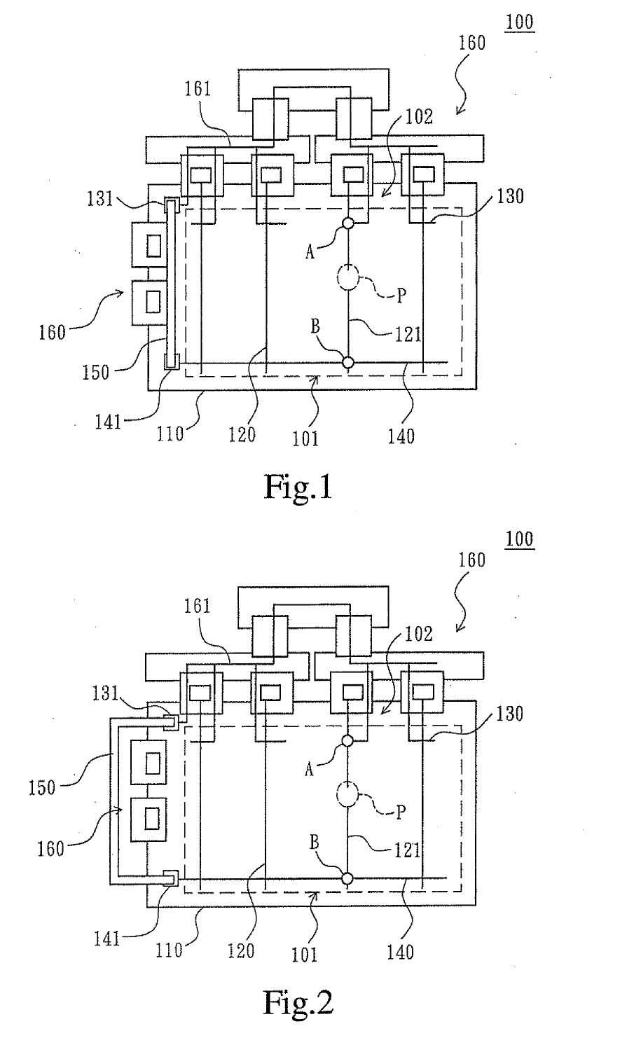

In order to make the illustration of the present invention more explicit and complete, the following description is stated with reference to FIG. 1 through FIG. 6.

Referring to FIG. 1, presented herein is a top view showing a display panel according to one embodiment of the present invention. The repair method can repair circuits of a display panel 100 which may be applicable to a liquid crystal display (LCD), an organic light emitting diode (OLED) display, a plasma display panel (PDP) or a field emission display (FED). Taking the LCD for example, the display panel 100 may be an LCD panel assembled with a backlight module, thereby forming the LCD.

Referring to FIG. 1 again, the display panel 100 of the present embodiment comprises a substrate 110, a plurality of signal lines 120, at least one first repair line 130, at least one second repair line 140, a flexible conductive component 150 and at least one driving circuit device 160. The substrate 110 may be a glass substrate or a flexible plastic substrate. In this embodiment, the substrate 110 may be a thin film transistor (TFT) array substrate having an active area 101 and at least one surrounding area 102. The active area 101 is configured to dispose the signal lines 120 and display image. The surrounding area 102 is formed on at least one side of the active area 101 configured to dispose the first repair line 130, the second repair line 140, the flexible conductive component 150 and the driving circuit device 160. When the display panel 100 is an LCD panel, it may further comprise a liquid crystal layer (not shown) and a color filter (CF) substrate (not shown). At this time, the liquid crystal layer is formed between the TFT array substrate (substrate 110) and the CF substrate.

Referring to FIG. 1 again, the material of the signal lines 120 may be Al, Ag, Cu, Mn, Mo, Cr, Ta, Ti, Mg, Zr or alloys thereof. The signal lines 120 are arranged in parallel manner on the substrate 110 and disposed across the active area 101 for transmitting signal, such as scanning signal, data signal or testing signal. In this embodiment, the signal lines 120 are arranged crisscrossed, and comprise a plurality of data lines arranged vertically and a plurality of scanning lines arranged in parallel. When one of the signal lines 120 (such as signal lines 121) of the display panel 100 has a broken point P, the signal line 121 is broken, and thus the display panel 100 may result in a defective product.

Referring to FIG. 1 again, the first repair line 130 or the second repair line 140 may be constituted by a continuous conductive wire or a plurality of conductive wire segments for repairing the broken signal line 121 of the display panel 100. The first repair line 130 is formed on one side of the signal lines 120 and partially overlaps the signal lines 120, i.e. the first repair line 130 and the signal lines 120 are partially crisscrossed, but not connected to each other. After repairing the display panel 100, the first repair line 130 can be electrically connected to the broken signal line 121 which has the broken point P. The second repair line 140 is formed on the opposite side of the signal lines 120 and partially overlaps the signal lines 120, i.e. the second repair line 140 and the signal lines 120 are also partially crisscrossed, but not connected to each other. After repairing the display panel 100, the second repair line 140 can be electrically connected to the broken signal line 121 which has the broken point P. In this embodiment, the first repair line 130 may be disposed on the signal input side of the signal lines 120, and the second repair line 140 may be disposed on the end side thereof. Furthermore, the first repair line 130 can have a first bonding pad 131 disposed at one end thereof, and the second repair line 140 can have a second bonding pad 141 disposed at one end thereof. The width of the first bonding pad 131 and the second bonding pad 141 are preferably larger than the width of the first repair line 130 and the second repair line 140 to make positioning and bonding the flexible conductive component 150 more convenient.

Referring to FIG. 1 and FIG. 2, FIG. 2 is a top view showing a display panel according to another embodiment of the present invention. The flexible conductive component 150 may be an electrically conductive device having low resistance and flexibility, such as a flexible flat cable (FFC), a flexible printed circuit (FPC) or a conductive wire. The flexible conductive component 150 is configured to electrically connect the first repair line 130 and the second repair line 140 for repairing the broken signal line 121 of the display panel 100 (i.e. one of the signal lines has the broken point P), wherein the signal transmission impedance of the flexible conductive component 150 is less than the signal transmission impedance of the circuit formed on the substrate 110. When mounting the flexible conductive component 150, the two opposite ends thereof can be bonded to the first bonding pad 131 of the first repair line 130 and the second bonding pad 141 of the second repair line 140, respectively, by welding, using a conductive glue, or an anisotropic conductive film (ACF), thereby forming the electrical connection between the first repair line 130 and the second repair line 140. When utilizing the flexible conductive component 150 to repair the display panel 100, the two opposite ends thereof are respectively connected to the first repair line 130 and the second repair line 140, and the other parts thereof can be curved and placed above (referring to FIG. 1), below or beside (referring to FIG. 2) the substrate 110 or at any other location positioning. In some embodiments, when the display panel 100 is applicable to the LCD, the flexible conductive component 150 can be curved and placed beside the backlight module or a frame (not shown).

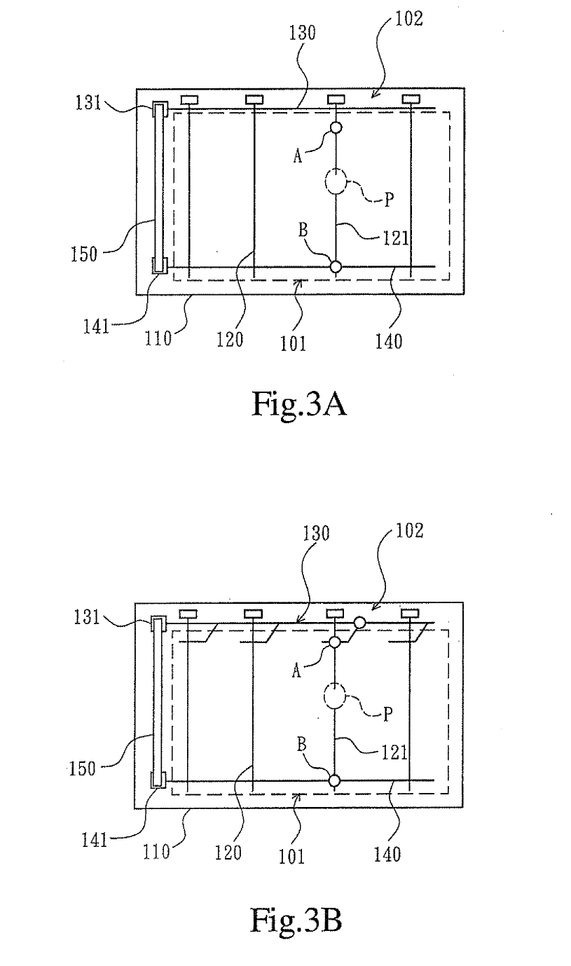

Referring to FIG. 1, FIG. 3 A and FIG. 3 B, FIG. 3 A and FIG. 3 B are schematic diagrams showing a display panel including repair lines on the substrate according to one embodiment of the present invention. The driving circuit device 160 may be a driving circuit, a driving chip (driving IC), a FPC, a printed circuit board (PCB), a printed-circuit board assembly (PCBA), a chip on board (COB), a chip on film (COF), a tape automatic bonding (TAB) film or any combination thereof. The driving circuit device 160 can be mounted on the surrounding area 102 of the display panel 100 by utilizing COB, COF, chip on glass (COG) or TAB technique. In this embodiment, the driving circuit device 160 may have a repair line 161 configured to be electrically connected to the first repair line 130 for reducing the signal transmission impedance. However, the first repair line 130 or the second repair line 140 can be directly formed on the substrate 110 by a continuous wire (referring to FIG. 3A) or a plurality of wire segments (referring to FIG. 3B) for repairing the display panel 100.

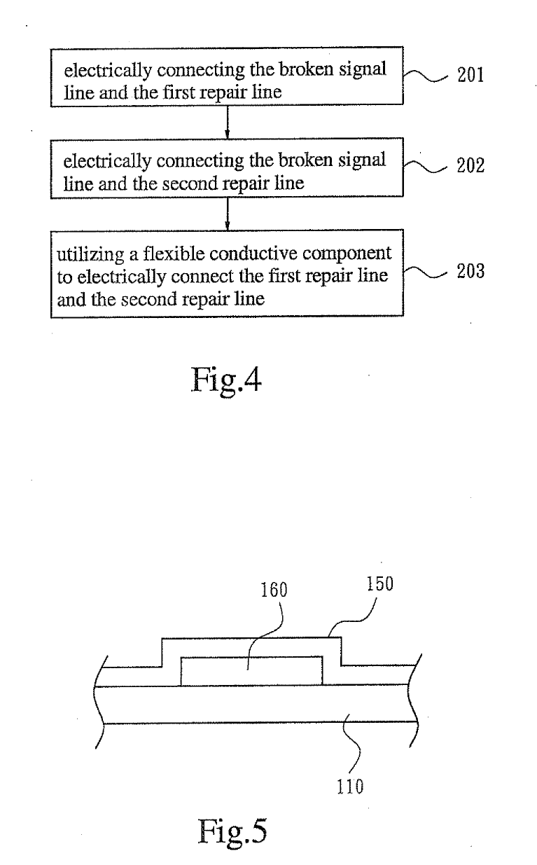

Referring to FIG. 1 and FIG. 4, FIG. 4 is a flow diagram showing a repair method of the display panel according to one embodiment of the present invention. Firstly, when utilizing the repair method of the present invention to repair the broken signal line 121 of the display panel 100, the first repair line 130 is electrically connected to the broken signal line 121 (step 201), and the second repair line 140 is electrically connected to the broken signal line 121 (step 202). Next, at this time, the overlapped portions between the broken signal line 121, the first repair line 130 and the second repair line 140 are melted by laser welding, thereby forming welding points A and B at the overlapped portions there between. Therefore, the electrically connection between the broken signal line 121, the first repair line 130 and the second repair line 140 are formed by the welding points A and B.

Referring to FIG. 1, FIG. 4 and FIG. 5, FIG. 5 is a partial cross-section view showing the display panel according to one embodiment of the present invention. The first repair line 130 and the second repair line 140 are electrically connected by utilizing the flexible conductive component 150 (step 203). At this time, two opposite ends of the flexible conductive component 150 are respectively bonded to the first bonding pad 131 of the first repair line 130 and the second bonding pad 141 of the second repair line 140, thereby electrically connecting the first repair line 130 and the second repair line 140 and achieving the repair of the display panel 100. Therefore, when the display panel 100 having the broken signal line 121 can not transmit signal normally, the signal can be transmitted by the route formed from the first repair line 130, the flexible conductive component 150 and the second repair line 140 for replacing the broken signal line 121, thereby repairing the display panel 100. In one embodiment, when mounting the flexible conductive component 150 on the display panel 100, firstly, the driving circuit device 160 can be mounted on the surrounding area 102 thereof and then the two ends of the flexible conductive component 150 are respectively mounted on the first bonding pad 131 of the first repair line 130 and the second bonding pad 141 of the second repair line 140. At this time, referring to FIG. 5, a portion of the flexible conductive component 150 is located above the driving circuit device 160 (such as a gate driving IC).

Therefore, the display panel 100 of the present embodiment and the repair method thereof can be used to repair circuits thereon, thereby preventing the display panel 100 unable to transmit signals and has to be discarded. Since the signal transmission impedance of the flexible conductive component 150 is very low, the RC-delay effect can be reduced to prevent signal distortion and enhance repair yield.

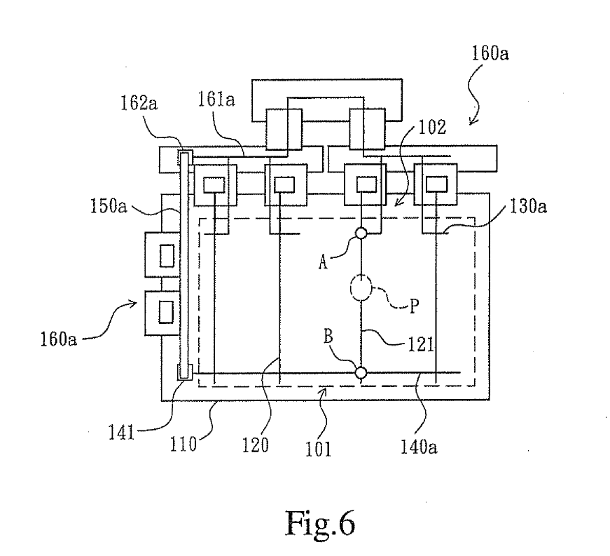

Referring to FIG. 6, presented herein is a top view showing a display panel according to yet another embodiment of the present invention. In this embodiment, the driving circuit device 160a may comprise a repair line 161a electrically connected to the first repair line 130a. At this time, one end of the flexible conductive component 150a is electrically connected to first repair line 130a by the repair line 161a, and the other end thereof is electrically connected to second repair line 140a. Therefore, the flexible conductive component 150a is electrically connected to the first repair line 130a by the repair line 161a, thereby forming the electrically connection between the first repair line 130a and the second repair line 140a. In this embodiment, the repair line 161a may have a bonding pad 162a to make positioning and bonding the flexible conductive component 150 convenient.

Therefore, the display panel of the present invention and the repair method thereof can be used to repair the broken signal line to prevent the panel from being discarded. Furthermore, the signal transmission impedance after repairing is very low, thereby enhancing the signal transmission quality and the repair yield of the signal line.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A display panel, comprising:
a substrate;
a plurality of signal lines formed on the substrate, wherein at least one of the signal lines is broken;
at least one first repair line formed on one side of the signal lines and electrically connected to the broken signal line;
at least one second repair line formed on the opposite side of the signal lines and electrically connected to the broken signal line; and
a flexible conductive component electrically connected between the first repair line and the second repair line.

2. The display panel as claimed in claim 1, wherein the display panel is a liquid crystal display (LCD) panel.

3. The display panel as claimed in claim 1, wherein the substrate is a thin film transistor (TFT) array substrate.

4. The display panel as claimed in claim 1, wherein the signal lines are a plurality of data lines and a plurality of scanning lines.

5. The display panel as claimed in claim 1, wherein the first repair line comprises a first bonding pad disposed at one end thereof, and the second repair line comprises a second bonding pad disposed at one end thereof, and two opposite ends of the flexible conductive component are respectively connected to the first bonding pad and the second bonding pad.

6. The display panel as claimed in claim 1, wherein the flexible conductive component is a flexible flat cable (FFC), a flexible printed circuit (FPC) or a conductive wire.

7. The display panel as claimed in claim 1, further comprising:
at least one driving circuit device mounted on at least one side of the signal lines.

8. The display panel as claimed in claim 7, wherein the driving circuit device comprises a repair line electrically connected to the first repair line, and one end of the flexible conductive component is connected to the repair line.

9. The display panel as claimed in claim 7, wherein the driving circuit device is a gate driving circuit, and a portion of the flexible conductive component is located above the gate driving circuit.

10. A repair method for a display panel, wherein the display panel comprises a plurality of signal lines, at least one first repair line and at least one second repair line, and at least one of the signal lines is broken, and the first repair line and the second repair line are respectively formed on two opposite sides of the signal lines and partially overlap the signal lines, and the method comprises:
electrically connecting the broken signal line and the first repair line;
electrically connecting the broken signal line and the second repair line; and
utilizing a flexible conductive component to electrically connect the first repair line and the second repair line.

11. The method as claimed in claim 10, wherein the broken signal line is electrically connected to the first repair line and the second repair line by laser welding.

12. The method as claimed in claim 10, wherein the flexible conductive component is bonded to the first repair line and the second repair line by welding, a conductive glue or an anisotropic conductive film (ACF).

13. The method as claimed in claim 10, wherein the first repair line comprises a first bonding pad disposed at one end thereof, and the second repair line comprises a second bonding pad disposed at one end thereof, and two opposite ends of the flexible conductive component are respectively connected to the first bonding pad and the second bonding pad.

14. The method as claimed in claim 10, wherein the flexible conductive component is a FFC, a FPC or a conductive wire.

15. The method as claimed in claim 10, wherein the display panel further comprises at least one driving circuit device mounted on at least one side of the signal lines, and the driving circuit device comprises a repair line electrically connected to the first repair line, and one end of the flexible conductive component is connected to the repair line.

16. The method as claimed in claim 10, wherein the display panel further comprises at least one gate driving circuit mounted on at least one side of the signal lines, and a portion of the flexible conductive component is located above the gate driving circuit.
